(19) United States
(12) Patent Application Publication
(10) Pub. No.: US 2012/0268312 A1
(43) Pub. Date: Oct. 25, 2012

(54) METHOD FOR MONITORING THE LAW OF ILLUMINATION OF A RADAR ANTENNA AND CORRESPONDING DEVICE

(75) Inventors: Jean-Paul Artis, Plouzane (FR); Stéphane Kemkemian, Paris (FR); Jean-Michel Quellec, Ploumoguer (FR)

(73) Assignee: THALES, NEUILLY SUR SEINE (FR)

(21) Appl. No.: 13/318,795

(22) PCT Filed: Jan. 11, 2010
(86) PCT No.: PCT/EP10/50224

§ 371 Date: Apr. 13, 2012

(30) Foreign Application Priority Data
Jan. 9, 2009 (FR) 0900081

(51) Int. Cl. G01S 13/00

(52) U.S. Cl. 342/91

(57) ABSTRACT

A method for controlling laws of illumination of a radar antenna with adjustable gain and/or phase, suitable for sending and for receiving a radar signal, the method including obtaining a position of an obstacle located in a near field of a beam of the radar antenna according to a direction of aim of said beam, calculating the laws of illumination on sending and on receiving of said radar antenna so as to adjust the direction of the aim of the radar beam while minimizing interaction and/or effects between the beam of the radar antenna and the obstacle, and implementing the calculated laws of illumination on sending and on receiving of the radar antenna.

The invention relates to the controlling of the law of illumination associated with a radar antenna, in particular in the presence of an obstacle in the near field of the beam of the antenna.

Solutions are known for dealing with the spurious reflections deriving from the distant environment. They generally include an adaptation of the antenna pattern, this pattern corresponding to the Fourier transform of the law of illumination of the antenna. However, these solutions are not at all suitable for dealing with the case of obstacles situated in the near field of the beam of the antenna.

When an obstacle appears in the field of the beam of a radar antenna, spurious radiation secondary lobes are formed, in particular when the obstacle is close to the radar antenna.

The latter are due to diffraction effects around the obstacle, or even to effects of reflection of the signal by the obstacle itself. The secondary lobes may be intense and oriented in directions that are notably far from the direction that is being targeted, and therefore significantly disrupt the function of the radar.

This phenomenon is encountered, for example, in the case of a radar antenna fixed to the mast of a ship. The mast constitutes a permanent and non-removable obstacle for this radar antenna, disturbing the signal received by the latter.

Another case is that of a surveillance radar situated on a ventral face of an aircraft, having within its field either auxiliary antennas, for example communication antennas, or even landing gear elements.

The harmful effects of an obstacle are felt all the more strongly when the latter is close to the antenna.

The existing solutions consist:
either in completely interrupting the operation of the radar antenna in the vicinity of an obstacle,
or in strongly desensitizing the radar, so as to avoid the appearance of the abovementioned phenomena.

These solutions have the disadvantage of the loss of functionality of the radar in the areas concerned.

The aim of the invention is notably to resolve the abovementioned problems, in particular in the case of the radar antennas of active type.

Generally, the invention applies to any antenna which has a gain and/or phase control, according to the position on the surface on sending or on receiving or both. It should be noted that, conventionally, a monostatic radar uses its antenna on sending and on receiving.

To this end, according to one aspect of the invention, there is proposed a method for controlling the law of illumination of a radar antenna with adjustable gain and/or phase, suitable for sending and for receiving a radar signal.

According to a general characteristic of this aspect, the method comprises, dynamically:
a knowledge of the position of an obstacle located in the near field of the beam of the radar antenna according to the direction of the aim of said beam,
a calculation of the laws of illumination on sending and on receiving of said radar antenna so as to adjust the direction of the aim of the radar beam while minimizing the interaction and/or its effects, between the beam of the radar antenna and the known obstacle,
an implementation of the laws of illumination on sending and on receiving of the radar antenna according to the calculation made.

In other words, for a given position of the beam of the radar antenna, the position of the hindering obstacle is known. The laws of illumination are modified accordingly, the radar antenna being of the type with distributed amplification. The modification of the laws of illumination makes it possible to reduce, even eliminate, the secondary lobes resulting from the obstacle located in the near field of the antenna. More specifically, and schematically, the implementation is made:
on the one hand so that the energy sent to the obstacle is as low as possible, even zero, and
on the other hand, so that the law of illumination is such that the resulting beam (as sending/receiving product) has a direction and secondary lobes that are controlled, in directions such that these lobes do not disturb the operation of the radar.

For information, it should be recalled that the concept of law of illumination is to be considered on the surface of the antenna, therefore according to two axes.

For example, the implementation of the laws of illumination may include a weighting of the gain of the radar signal sent according to the position of the determined obstacle.

For example, the implementation of the laws of illumination may include a weighting of the phase of the radar module sent according to the position of the determined obstacle.

It should be noted that, when implementing the laws of illumination in sending and in receiving modes, the phase can be adjusted (by weighting for example) on its own, or together with the gain, or vice versa.

The weighting techniques to obtain a given pattern are assumed to be known to those skilled in the art.

According to one implementation, the implementation of the laws of illumination may include the activation and/or the deactivation of modules for illuminating said radar antenna, said modification then comprising a deactivation of the illumination modules generating the portion of antenna entering into interaction with said obstacle.

For example, said antenna may be of “active” type.

As a variant, said antenna may be of “passive” type incorporating gain- and/or phase-controlled illumination modules.

For example, said antenna may be of electronic scanning type, such as the antennas of PESA (“Passive Electronic Scanning”) type or AESA (“Active Electronic Scanning”) type.

According to another aspect of the invention, there is proposed a device for controlling the law of illumination of a radar antenna of distributed amplification type.

According to a general characteristic of this other aspect, the device is suitable for implementing the method as described hereinabove.

According to another aspect, there is proposed the use of a controlling device as mentioned above, in a vehicle, in particular an aircraft or a boat.

Other advantages and features of the invention will become apparent from studying the detailed description and an implementation of the invention, in no way limiting, and the appended drawings in which:

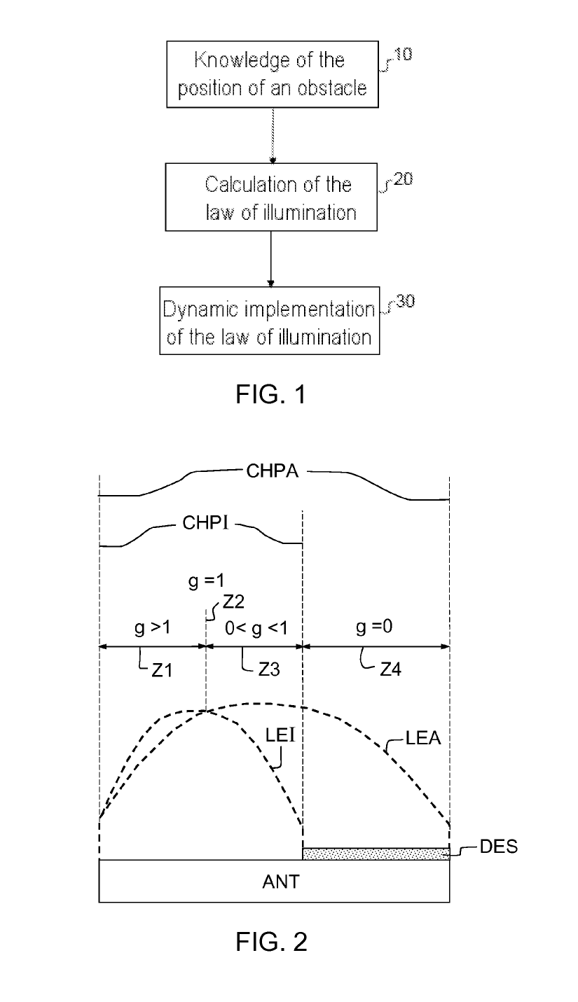

FIG. 1 illustrates an implementation of a method for controlling the law of illumination of a radar antenna according to the invention, and

FIG. 2 represents an example of a law of illumination of a radar antenna according to the invention.

Reference is made first to FIG. 1. This figure illustrates an example of an implementation of a controlling method according to the invention.

First of all, during a first step 10, the position of a hindering obstacle is recognized (for example by a technician capable of operating the radar antenna). This obstacle is situated in the near field of the antenna. This concept of “near field”, well known to those skilled in the art, denotes the area around the antenna, which is delimited by a boundary situated at a distance of (0.5)d²/λ from the latter.

d is the largest dimension of the antenna and λ is the wavelength of the signal implemented by the antenna.

This obstacle may be the mast of a ship in the case of a radar fixed to the end of the latter.

In another use, the obstacle may be another antenna or a landing gear element of an aircraft for a surveillance radar.

When the antenna beam scans the space, it regularly encounters the mast to which it is fixed. Obviously, this example of use is not limiting.

Once the obstacle and its position are known, the law of illumination of said radar antenna is calculated so as to reduce the interaction between the beam of the radar antenna and the determined obstacle, step 20.

As indicated above, the interaction of the antenna beam with an obstacle promotes the appearance of secondary radiation lobes by diffraction effect. The latter disturb the reception of the echoes returned by the environment and make it more difficult to interpret the radar images. The disturbances are all the more significant when the obstacle is close to the radar antenna.

In other words, the equations governing the appearance of the curve representative of the law of illumination are determined. For example, it is possible to modify the gain of the signal sent by the antenna for the power of this signal to be attenuated a lot in the direction of the obstacle.

Once the calculation is made, the law of illumination of the antenna is dynamically implemented, 30.

This dynamic implementation can be done in a number of ways. For example, the gain and/or the phase of the signal sent by the radar antenna can be controlled so as to obtain the desired law of illumination.

This is made possible by the use of radar antennas of the type with adjustable gain and/or phase, such as the electronic scanning antennas.

Such is the case in particular of the so-called active electronic scanning antennas.

This is because an active array antenna includes, in its architecture, an amplification and a reception that are distributed, that is to say that the radio frequency amplification elements are positioned between the input point of the array antenna and the radiant elements forming said array antenna. These amplification elements (or amplifiers) are generally modules that can be used both in receiving and in sending modes. They sometimes include phase-shifting elements for pointing the beam sent by the array antenna in directions other than the normal to the array antenna.

The antenna used may also be an antenna of passive electronic scanning type.

The latter then includes phase shifters and/or attenuators controlled upstream of its radiant elements.

Reference is now made to FIG. 2 which illustrates a modification of the law of illumination of a radar antenna due to the presence of an obstacle.

The reference ANT denotes an antenna, which is, in this example, of active type. More specifically, the rectangle ANT denotes a projection of the active part of the antenna onto the phase plane of the waves delivered at the output of this antenna ANT.

The field of the beam of the antenna is referenced CHPA and is here seen from above (the law of illumination is not yet modified). In the so-called “near field” area of the antenna ANT, the radiated energy takes the form of quasi-planar waves and are contained in a cylinder.

An obstacle OBT is situated in the field CHPA of the antenna ANT.

With no modification to the law of illumination according to the invention, the latter has the appearance of the broken line curve LEA. It is associated with the field CHPA and does not make it possible to avoid the obstacle OBT.

Once the law of illumination is modified so as to avoid the interferences with the obstacle OBT, the latter has the appearance of the dotted line curve referenced LEI. This curve is associated with a new field CHPI.

The gain has been weighted relative to the gain of the signal sent by the radar antenna before modification. The gain applied to the signal sent with no modification is equal to “1”. The weighting used may be a Gauss weighting.

Four distinct areas are identified:
the area Z1 where the gain g of the signal sent according to the law of illumination LEI is greater than 1 (the curve referenced LEI goes above the curve referenced LEA);
the area Z2 where the gain g is equal to “1” (the curve referenced LEI intersects the curve referenced LEA),
the area Z3 where the gain g of the signal sent according to the law of illumination LEI is less than 1 (the curve referenced LEI goes below the curve referenced LEA), and
the area Z4 where the gain g is zero (the curve referenced LEI is cancelled).

This last area Z4 is obtained by deactivating the radiant elements of the antenna ANT. The deactivated radiant elements are symbolized by a shaded area DES.

It will thus be noted that the power of the signal sent is greatly reduced, even cancelled, in the direction of the obstacle OBT, thus limiting the interferences between the two elements.

The same applies in receiving mode.

The areas Z1, Z2 and Z3 define the new field of the beam of the antenna, the latter avoiding the obstacle OBT.

It will be noted that the modification of the law of illumination is independent of the scanning mode of the antenna used (mechanical, electronic or hybrid).

Obviously, the implementations described above are absolutely not limiting.

Variants can easily be defined through the use of the capacity for controlling gain and phase on the surface of the antenna both on sending and on receiving.

This control may, for example, also be carried out according to the following principles:
not to receive energy from the obstacle (when the antenna is operating in receiving mode),
in sending mode, to radiate the energy intended for the obstacle, but, by virtue of the phase control, to send it in a direction such that the radar operation is not affected thereby (for example, to the ground for a radar in a ventral position on an aircraft, or even in a direction such that the gain of the radiant elements for this direction is low), and
likewise in receiving mode, to radiate the energy from the obstacle in a chosen direction.

Obviously, the control of the pattern of a radiant aperture by control of its laws of illumination in gain and in phase is known to those skilled in the art.

1. A method for controlling laws of illumination of a radar antenna with adjustable gain and/or phase, suitable for sending and for receiving a radar signal, the method comprising:
obtaining a position of an obstacle located in a the near field of a the beam of the radar antenna according to a the direction of the aim of said beam
calculating the laws of illumination on sending and on receiving of said radar antenna so as to adjust the direction of the aim of the radar beam while minimizing interaction and/or effects between the beam of the radar antenna and the obstacle; and
implementing the calculated laws of illumination on sending and on receiving of the radar antenna.

2. The method according to claim 1, wherein the implementing the laws of illumination includes a weighting of the gain of the radar signal sent according to the position of the determined obstacle.

3. The method according to claim 1, wherein the implementing the laws of illumination includes a weighting of the phase of the radar signal sent according to the position of the determined obstacle.

4. The method according to claim 1, wherein the implementing the laws of illumination includes the activation and/or deactivation of modules for illuminating said radar antenna, comprising a deactivation of the illumination modules generating a portion of said antenna entering into interaction with said obstacle.

5. The method according to claim 1, wherein said antenna is of an “active” type.

6. The method according to claim 1, wherein said antenna is of a “passive” type incorporating gain- and/or phase-controlled illumination modules.

7. The method according to claim 1, wherein said antenna is of an electronic scanning type.

8. A device for controlling the law laws of illumination of a radar antenna of distributed amplification type, characterized in that it is suitable for implementing configured to implement the method as claimed in one of the preceding claims according to claim 1.

9. A method for controlling laws of illumination of a radar antenna of distributed amplification type, the method comprising
use of a controlling device according to claim 8, in an aircraft or a boat.
